(19) United States
(12) Patent Application Publication
(10) Pub. No.: US 2026/0334492 A1
(43) Pub. Date: Oct. 29, 2026

(54) METHOD FOR PRODUCING HIGH-PROTEIN MILK RAW MATERIAL

(71) Applicant: MEIJI CO., LTD., Tokyo (JP)

(72) Inventors: Anri KUROKI, Tokyo (JP); Hiroshi HORIUCHI, Tokyo (JP); Hiroshi ECHIZEN, Tokyo (JP)

(73) Assignee: MEIJI CO., LTD., Tokyo (JP)

(21) Appl. No.: 19/111,572

(22) PCT Filed: Sep. 13, 2023
(86) PCT No.: PCT/JP2023/033458

§ 371 Date: Mar. 13, 2025

(30) Foreign Application Priority Data
Sep. 14, 2022 (JP) 2022-146502

(51) Int. Cl. A23C 9/123; A23C 21/02; A23C 21/06

(52) U.S. Cl. CPC A23C 9/1238; A23C 9/1232; A23C 21/02; A23C 21/06; A23V 2400/123; A23V 2400/125

(57) ABSTRACT

Provided is a method for producing a dairy material with a high protein content (high-protein dairy material), in particular a method for producing a high-protein dairy material with improved flavor. The production method includes the steps of (1) preparing a milk fluid from a dairy material, the milk fluid having a total solids content of 5 to 15 mass % and containing milk-derived proteins in an amount of 50 parts by mass or more per 100 parts by mass of the total solids content; and (2) adding lactic acid bacteria to the milk fluid and maintaining the milk fluid containing the lactic acid bacteria until achieving a pH within the range of 5.2 to 6.5 to obtain a lactic acid bacteria-treated milk fluid with a pH within the range.

### CROSS-REFERENCE TO RELATED PATENT APPLICATIONS

The present application claims priority based on Japanese Patent Application No. 2022-146502, filed on Sep. 14, 2022, the entire disclosure of which is incorporated herein by reference.

### TECHNICAL FIELD

The present invention relates to a method for producing a dairy material having a high protein content (referred to as a “high-protein dairy material” in the present invention). The present invention also relates to a high-protein dairy material with improved flavor. The present invention further relates to a food or drink product containing the high-protein dairy material, and a production method thereof. The present invention further relates to a method for improving the flavor of a high-protein dairy material.

### BACKGROUND ART

For example, high-protein dairy materials that contain 50 mass % or more of milk-derived proteins (“milk-derived protein” below), such as milk protein concentrate (MPC) and whey protein concentrate (WPC), have protein odors unique to milk-derived protein. For this reason, a food or drink containing such materials in a predetermined amount may have impaired flavor.

To improve this, a method has been proposed in which amino acids and/or sweeteners such as glycine and/or aspartame are added to protein-containing drinks to mask the casein odor derived from milk proteins (PTL 1). However, glycine and aspartame are both sweet substances; thus, they may affect or impair the flavor of protein-containing drinks depending on the amount of these added.

Alternative methods are also proposed, such as a method of bringing a high-protein milk fluid having a protein content of 60 mass % or more of the total solids content into contact with activated carbon, or a method of concentrating the fluid using a nanofiltration membrane (PTL 2 and 3). These methods are useful for obtaining high-protein dairy materials with reduced milk-derived protein odors and improved refreshing taste, but require equipment such as activated carbon columns and filters, as well as membrane module units.

A method using fermentation technology is known as a method for masking odors. For example, PTL 4 discloses a method for masking aloe-derived odors of aloe-containing fermented milk, in which a fermented milk base is prepared by fermenting a fermented milk material containing bacteria of the genus Bifidobacterium and a lactic acid bacteria starter until the pH reaches 4.4 to 4.8, and the fermented milk base is mixed with a predetermined amount of an aloe gel dispersion, thereby reducing the grassy odor unique to aloe gel. PTL 5 discloses a method for reducing grassy odors, bitterness, and astringent taste that are unique to soybeans in a lactic acid-fermented soy milk food, in which soy milk is fermented using one or more lactic acid bacteria strains selected from Lactobacillus paracasei tolerance N-5 strain (accession number: NITE P-02630), Lactococcus lactis hordniae Lhana strain (accession number: NITE P-02631), and Lactobacillus pentosus Lpome-3 strain (accession number: NITE P-02632) as a lactic acid bacteria starter used in the production of the lactic acid-fermented soy milk food. PTL 5 states that this process reduces the unpleasant odor (grassy odor) and unpleasant taste (bitterness and astringent taste) unique to soybeans.

### CITATION LIST

### Patent Literature

PTL 1: JP2020-141559A
PTL 2: WO2020/085517A
PTL 3: WO2020/085518A
PTL 4: JP2017-176030A
PTL 5: JP2019-165667A

### SUMMARY OF INVENTION

### Technical Problem

A first object of the present invention is to provide a method for producing a dairy material containing a high amount of protein (high-protein dairy material). Preferably, the object is to provide a method for producing a high-protein dairy material with reduced protein odors due to milk-derived protein (“milk-derived-protein odors” below).

A second object of the present invention is to provide a high-protein dairy material that has been treated with lactic acid bacteria (“lactic acid bacteria-treated high-protein dairy material” below). Preferably, the object is to provide a lactic acid bacteria-treated high-protein dairy material with reduced milk-derived-protein odors.

A third object of the present invention is to provide a novel food or drink product containing a lactic acid bacteria-treated high-protein dairy material, and a production method thereof.

A fourth object of the present invention is to provide a method for improving the flavor of a high-protein dairy material by reducing milk-derived-protein odors in the high-protein dairy material.

### Solution to Problem

The present inventors conducted extensive research to achieve the objects above and found that it is possible to obtain a high-protein dairy material with reduced protein odors caused by proteins derived from milk (milk-derived protein odor) and improved flavor, compared to a high-protein dairy material prepared without lactic acid bacteria treatment, by preparing a milk fluid from a dairy material having a total solids content of 5 to 15 mass % and containing a milk-derived protein in an amount of 50 parts by mass or more per 100 parts by mass of the total solids content, and then maintaining the milk fluid using lactic acid bacteria until the milk fluid reaches a pH within the range of 5.2 to 6.5 (excluding the pH range within which curd is formed) (lactic acid bacteria treatment).

The present invention was completed based on this finding and through further research, and includes the following embodiments.

### (I) Method for Producing High-Protein Dairy Material

(I-1) A method for producing a high-protein dairy material comprising the steps of
   (1) preparing a milk fluid from a dairy material, the milk fluid having a total solids content of 5 to 15 mass %, and containing a milk-derived protein in an amount of 50 parts by mass or more per 100 parts by mass of the total solids content, and
   (2) adding lactic acid bacteria to the milk fluid and maintaining the milk fluid containing the lactic acid bacteria until reaching a pH within the range of 5.2 to 6.5 (lactic acid bacteria treatment) to obtain a lactic acid bacteria-treated milk fluid with a pH within the range.
(I-2) The method according to (I-1), further comprising the step of (3-1) concentrating the lactic acid bacteria-treated milk fluid or concentrating and drying the lactic acid bacteria-treated milk fluid.
(I-3) The method according to (I-1), further comprising the step of (3-2) drying the lactic acid bacteria-treated milk fluid.
(I-4) The method according to any one of (I-1) to (I-3), wherein the milk fluid contains whey protein as a milk-derived protein but does not contain casein.
(I-5) The method according to any one of (I-1) to (I-3), wherein
   the milk fluid contains casein, or casein and whey protein, as a milk-derived protein,
   step (2) includes maintaining the milk fluid containing the lactic acid bacteria until achieving a pH within the range of 6.0 to 6.5 (lactic acid bacteria treatment) to obtain a lactic acid bacteria-treated milk fluid with a pH within the range.
(I-6) The method according to (I-4), wherein the high-protein dairy material is at least one member selected from the group consisting of whey protein concentrate (WPC) and whey protein isolate (WPI).

The WPC and WPI have been treated with lactic acid bacteria.
(I-7) The method according to (I-5), wherein the high-protein dairy material is at least one member selected from the group consisting of milk protein concentrate (MPC), milk protein isolate (MPI), and micellar casein concentrate (MCC).

The MPC, MPI, and MCC have been treated with lactic acid bacteria.
(I-8) The method according to any one of (I-1) to (I-7), not comprising the step of treating the milk fluid obtained in step (1) or the lactic acid bacteria-treated milk fluid obtained in step (2) with activated carbon.

The production method of the present invention improves the flavor of a high-protein dairy material by treating the milk fluid obtained in step (1) with lactic acid bacteria. Thus, the method of the present invention is distinguished from techniques that attempt to improve flavor by removing impurities using activated carbon treatment etc.

### (II) Lactic Acid Bacteria-Treated High-Protein Dairy Material

(II-1) A lactic acid bacteria-treated high-protein dairy material, which is in a liquid form, comprising a milk-derived protein in an amount of 50 parts by mass or more per 100 parts by mass of the total solids content,
   the lactic acid bacteria-treated high-protein dairy material comprising at least dead lactic acid bacteria cells, diacetyl, and 3-hydroxy-2-butanone, and
   the lactic acid bacteria-treated high-protein dairy material having a pH within the range of 5.2 to 6.5.
(II-2) The lactic acid bacteria-treated high-protein dairy material according to (II-1), wherein the lactic acid bacteria-treated high-protein dairy material contains whey protein as the milk-derived protein but does not contain casein.
(II-3) The lactic acid bacteria-treated high-protein dairy material according to (II-1),
wherein
   the lactic acid bacteria-treated high-protein dairy material contains casein, or casein and whey protein as the milk-derived protein, and
   the lactic acid bacteria-treated high-protein dairy material has a pH within the range of 6.0 to 6.5.
(II-4) A semi-solid or solid lactic acid bacteria-treated high-protein dairy material obtained by concentrating and/or drying the lactic acid bacteria-treated high-protein dairy material in a liquid form of any one of (II-1) to (II-3).

### (III) Food or Drink Product and Method for Producing Food or Drink Product

(III-1) A method for producing a food or drink product, comprising the step of adding the high-protein dairy material obtained according to the method of any one of (I-1) to (I-8) to a food or drink product.
(III-2) A food or drink product comprising the lactic acid bacteria-treated high-protein dairy material of any one of (II-1) to (II-4).

### (IV) Method for Improving Flavor of High-Protein Dairy Material

(IV-1) A method for improving flavor of a high-protein dairy material, comprising the steps of
   (1) preparing a milk fluid from a dairy material, the milk fluid having a total solids content of 5 to 15 mass % and containing a milk-derived protein in an amount of 50 parts by mass or more per 100 parts by mass of the total solids content, and
   (2) adding lactic acid bacteria to the milk fluid and maintaining the milk fluid containing the lactic acid bacteria until reaching a pH within the range of 5.2 to 6.5 (lactic acid bacteria treatment) to obtain a lactic acid bacteria-treated milk fluid with a pH within the range.

### Advantageous Effects of Invention

The high-protein dairy material produced according to the production method of the present invention has significantly reduced protein odors derived from milk as compared to high-protein dairy materials that have not been treated with lactic acid bacteria. Thus, the present invention can provide a high-protein dairy material with reduced milk-derived-protein odors and improved flavor. Additionally, despite containing a milk-derived protein in an amount of as high as 50 parts by mass or more per 100 parts by mass of the total solids content, the high-protein dairy material of the present invention has reduced milk-derived-protein odors and thus can be added to food or drink products without compromising the flavor. Furthermore, the method for improving flavor according to the present invention can significantly reduce milk-derived-protein odors in a high-protein dairy material compared to high-protein dairy materials that have not been treated with lactic acid bacteria.

### DESCRIPTION OF EMBODIMENTS

### (I) Method for Producing High-Protein Dairy Material

The production method of the present invention comprises at least the following steps:
(1) preparing a milk fluid from a dairy material, the milk fluid having a total solids content of 5 to 15 mass % and containing a milk-derived protein in an amount of 50 parts by mass or more per 100 parts by mass of the total solids content (this step is also referred to as “milk fluid preparation step” below), and
(2) adding lactic acid bacteria to the milk fluid and maintaining the milk fluid containing the lactic acid bacteria until achieving a pH within the range of 5.2 to 6.5 (lactic acid bacteria treatment) to obtain a lactic acid bacteria-treated milk fluid with a pH within the range (this step is also referred to as “lactic acid bacteria treatment step”).

The production method of the present invention can be described as a method for producing a high-protein dairy material with significantly reduced milk-derived-protein odors as compared to high-protein dairy materials that are not treated with lactic acid bacteria. Preferably, the production method of the present invention can be described as a method for producing a high-protein dairy material with significantly reduced milk-derived-protein odors and a refreshing aftertaste (improved refreshing feel) compared to high-protein dairy materials that are not treated with lactic acid bacteria. In particular, the production method of the present invention, in which the pH used in the lactic acid bacteria treatment step is 6.0 to 6.5, can be described as a method for producing a high-protein dairy material with significantly reduced milk-derived-protein odors and a refreshing aftertaste (improved refreshing feel) but without sourness (with no sour taste), compared to high-protein dairy materials that are not treated with lactic acid bacteria.

### (1) Milk Fluid Preparation Step

The “dairy material” used as a starting material in the milk fluid preparation step is a raw material for preparing a milk fluid having a total solids content of 5 to 15 mass %, and containing a milk-derived protein in an amount of 50 parts by mass or more per 100 parts by mass of the total solids content; as long as this requirement is met, it is sufficient if the dairy material contains at least a milk-derived protein as a milk component. As long as the effects of the present invention are not adversely affected, the dairy material may also contain other milk components, such as milk fat, lactose, and/or ash. The dairy material can be of any form, but may be, for example, a fluid such as a liquid or semi-solid (such as a gel), or may be a dry solid (such as powder, particles, granules, or tablets) containing a milk component.

Examples of dairy materials include raw milk squeezed from cows, cow milk (whole milk), skim milk, whole milk powder, skim milk powder, full-fat concentrated milk, concentrated skim milk, whey, whey powder, desalted whey, desalted whey powder, whey protein concentrate (WPC), whey protein isolate (WPI), milk protein concentrate (MPC), milk protein isolate (MPI), and micellar casein concentrate (MCC).

The dairy material is not particularly limited, and is preferably a dairy material having a high content of a milk-derived protein relative to the total solids content, and specific examples include whey protein concentrate (WPC), whey protein isolate (WPI), milk protein concentrate (MPC), milk protein isolate (MPI), and micellar casein concentrate (MCC).

The milk fluid prepared in the milk fluid preparation step has a total solids content of 5 to 15 mass % and contains a milk-derived protein in an amount of 50 parts by mass or more per 100 parts by mass of the total solids content. The milk fluid includes liquid and semi-solid fluids that contain a high concentration of a milk-derived protein.

The total solids content of the milk fluid may be within the range of 5 to 15 mass %, as described above, and is preferably 6 to 14 mass %, more preferably 7 to 13 mass %, and even more preferably 8 to 12 mass %. The “total solids content” as used herein refers to the percentage of the total amount of solids contained in 100 mass % of the milk fluid. The total solids content includes the milk components contained in the milk fluid (e.g., milk-derived proteins, milk fat, carbohydrates, and ash).

As described above, the amount of the milk-derived protein per 100 parts by mass of the total solids content in the milk fluid may be 50 parts by mass or more, preferably 60 parts by mass or more, more preferably 70 parts by mass or more, even more preferably 75 parts by mass or more, and particularly preferably 80 parts by mass or more. The upper limit is not limited, but may be 95 parts by mass, for example.

The “amount of the milk-derived protein per 100 parts by mass of the total solids content” means the percentage (parts by mass) of the milk-derived protein of the total amount of solids, taken as 100 parts by mass, contained in the milk fluid. The total amount of solids contained in a milk fluid can be measured in accordance with ISO6731 (IDF21 Milk-Determination of total solids content). The protein content in a milk fluid can be calculated by multiplying the nitrogen content measured according to the combustion method or the Kjeldahl method by the nitrogen-to-protein conversion factor.

The milk fluid is not particularly limited. Preferable examples include a retentate obtained by treating cheese whey and/or acid whey with an ultrafiltration (UF) membrane, a permeate or retentate obtained by treating retentate obtained by treating cheese whey and/or acid whey with an ultrafiltration (UF) membrane with a microfiltration (MF) membrane, a retentate obtained by treating whole fat milk and/or skim milk with an ultrafiltration (UF) membrane, a permeate or retentate obtained by treating retentate obtained by treating whole fat milk and/or skim milk with an ultrafiltration (UF) membrane with a microfiltration (MF) membrane, a permeate or retentate obtained by treating whole fat milk and/or skim milk with a microfiltration (MF) membrane, whey protein concentrate (WPC: protein accounting for about 80 mass % of the total solids content), whey protein isolate (WPI: protein accounting for about 90 mass % of the total solids content), milk protein concentrate (MPC: protein accounting for about 80 mass of the total solids content), milk protein isolate (MPI: protein accounting for about 90 mass % of the total solids content), and micellar casein concentrate (protein accounting for about 80 mass % of the total solids content).

In the above, the term “retentate” refers to a liquid that does not permeate a membrane in membrane treatment, and is retained on the membrane and concentrated (“concentrated liquid”). The term “permeate” refers to a liquid that has permeated the membrane in membrane treatment. For example, subjecting a retentate obtained by subjecting cheese whey and/or acid whey to UF treatment to MF membrane treatment allows components other than whey protein to retain on the MF membrane, thereby providing a permeate with an increased concentration of whey protein. Subjecting a retentate obtained by concentrating proteins from whole milk and/or skim milk through UF membrane treatment to MF membrane treatment results in a retentate with selectively enriched micellar casein and a permeate containing whey protein.

The method for preparing the milk fluid from the dairy material is not particularly limited, so long as it is a method for preparing a milk fluid having a total solids content of 5 to 15 mass % and containing a milk-derived protein in an amount of 50 parts by mass or more per 100 parts by mass of the total solids content by using one type or a combination of two or more types of the dairy material. Examples of such methods include a method of using the dairy material as is or a combination of two or more types of the dairy material, a method of dissolving (reducing) the dairy material in water or hot water (warm water, hot water), a method of further subjecting the dairy material or its reduced product to degreasing treatment and then membrane treatment, and a method of subjecting the dairy material or its reduced product to acid treatment or enzyme treatment and then membrane treatment.

The milk fluid thus prepared is preferably pasteurized before being subjected to a lactic acid bacteria treatment step described below. The pasteurization may be performed so long as it does not interfere with the lactic acid bacteria treatment described below, and is preferably performed until the general bacteria count in the milk fluid falls to 1000 cfu/ml or less. The pasteurization may be performed according to any method under any conditions that can achieve this purpose, and is not particularly limited. Examples of pasteurization include heat treatment methods used for pasteurizing milk, such as ultra-high temperature flash pasteurization (UHT pasteurization) in which heat treatment is performed at 120 to 150 °C for 2 to 3 seconds, high-temperature short-time pasteurization (HTST pasteurization) in which heat treatment is performed continuously at 72 °C or higher, for example, 72 to 75 °C for 15 seconds or more, high-temperature long-time pasteurization (HTLT) in which heat treatment is performed in a holding mode at 75 °C or higher for 15 minutes or more, low-temperature long-time pasteurization (LTLT pasteurization) in which heat treatment is performed in a holding mode at 63 to 65 °C for 30 minutes, low-temperature long-time pasteurization (LTLT pasteurization) in which heat treatment is performed in a continuous mode at 65 to 68 °C for 30 minutes or more, and long-life pasteurization (LL pasteurization) in which heat treatment is performed at 135 to 150 °C for 1 to 4 seconds. Additionally, the pasteurization is not limited to the methods above, and it is sufficient if the heat history represented by heating temperature (product temperature)×heating time×pressure is equal to or greater than the pasteurization methods above. For example, as will be described in the Experimental Examples below, a method of heating the milk fluid under normal pressure conditions until the product temperature reaches 95 °C (achieving temperature: 95 °C) can be used. The “normal pressure” as used herein means that the pressure inside a container is in a normal pressure state, and does not include a pressure state in which the pressure has been artificially increased or decreased.

### (2) Lactic Acid Bacteria Treatment Step

The lactic acid bacteria used in the lactic acid bacteria treatment step are not particularly limited, and may be those commonly used in the production of fermented milk, such as Lactobacillus bulgaricus (L. bulgaricus), Streptococcus thermophilus (S. thermophilus), Lactobacillus casei (L. casei), Lactobacillus lactis (L. lactis), Lactobacillus gasseri (L. gasseri), Lactobacillus plantarum (L. plantarum), Lactobacillus acidophilus (L. acidophilus), and Bifidobacteria. Lactic acid bacteria for use can be one species or a combination of two or more species.

In an embodiment in which one species of lactic acid bacteria is used, the lactic acid bacteria for use are preferably Lactobacillus bulgaricus, Streptococcus thermophilus, or Lactobacillus casei. More preferably, the lactic acid bacteria for use are Lactobacillus bulgaricus 1589 (NITE BP-03716), Lactobacillus bulgaricus OLL 1073R-1 (FERM P-17227), Streptococcus thermophilus 3078 (NITE BP-01697), or casei P2203401. In an embodiment in which two or more species of lactic acid bacteria are used in combination, the lactic acid bacteria for use are preferably a combination of Lactobacillus bulgaricus and Streptococcus thermophilus, more preferably a combination of Lactobacillus bulgaricus 1589 and Streptococcus thermophilus 3078 or a combination of Lactobacillus bulgaricus OLL 1073R-1 and Streptococcus thermophilus 3078, and even more preferably a combination of Lactobacillus bulgaricus 1589 and Streptococcus thermophilus 3078. Additionally, as a combination of Lactobacillus bulgaricus and Streptococcus thermophilus, lactic acid bacteria isolated from fermented dairy products (e.g., Meiji Bulgaria Yogurt, Meiji Probio Yogurt LG 21, Meiji Probio Yogurt R-1, Meiji Bulgaria Yogurt dessert type, etc.) can also be used.

The amount of lactic acid bacteria added to the milk fluid is not particularly limited, and may be, for example, 10⁶ to 10⁸ cfu/ml, preferably 5×10⁶ to 10⁸ cfu/ml, and more preferably 10⁷ to 10⁸ cfu/ml relative to the milk fluid.

The lactic acid bacteria treatment can be performed on a milk fluid by adding lactic acid bacteria to the milk fluid and then allowing the milk fluid to stand or be stirred and maintained at a predetermined temperature.

The temperature for the lactic acid bacteria treatment is not particularly limited as long as it is a temperature at which the milk fluid (having an initial pH of about 7.0) can be adjusted to a final pH within the range of 5.2 to 6.5 to the extent that no curd is formed. The lower limit of the temperature for the lactic acid bacteria treatment is, for example, 30 °C, preferably 32 °C, more preferably 34 °C, and even more preferably 36 °C. The upper limit of the temperature for the lactic acid bacteria treatment is, for example, 45 °C, preferably 44 °C, and more preferably 43 °C. The temperature range for the lactic acid bacteria treatment can be set by combining these lower and upper limits as appropriate. Examples of the temperature range that can be selected include, but are not limited to, 30 to 45 °C, 32 to 44 °C, 34 to 43 °C, and 36 to 43 °C.

An example of the method for allowing the milk fluid to stand is allowing the milk fluid to stand in a jacketed tank or a constant-temperature room. The method for stirring and maintaining the milk fluid may be any method under any conditions that can at least uniformly stir and mix the milk fluid. An example is a method of stirring and mixing the milk fluid with a stirring blade, in which the milk fluid is maintained in a jacketed tank or a constant-temperature room.

The time for the lactic acid bacteria treatment is not particularly limited as long as it is a time that allows the milk fluid (having an initial pH of about 7.0) to be adjusted to a final pH within the range of 5.2 to 6.5 to the extent that no curd is formed. In other words, the lactic acid bacteria treatment can be ended at a point in time at which the pH falls within the range of 5.2 to 6.5 without allowing the lactic acid bacteria-treated milk fluid to form curd. The lower limit of the time of the lactic acid bacteria treatment is, but not limited to, for example, 0.5 hours, preferably 1 hour, more preferably 1.5 hours, and even more preferably 2 hours. The upper limit of the time of the lactic acid bacteria treatment is, for example, 12 hours, preferably 10 hours, more preferably 9 hours, and even more preferably 8 hours. The time range for the lactic acid bacteria treatment can be set by combining these lower and upper limits as appropriate. Although not limited thereto, examples of the time range that can be selected include 0.5 to 12 hours, 1 to 10 hours, 1.5 to 9 hours, and 2 to 8 hours.

The lactic acid bacteria treatment can be ended by heating the lactic acid bacteria-treated milk fluid to kill all or some of the lactic acid bacteria contained in the milk fluid or to reduce the activity of all or some of the lactic acid bacteria. The method and conditions for this heat treatment are not particularly limited as long as they can achieve the purpose above and do not interfere with the effects of the present invention. For example, a method of heating the milk fluid until its temperature reaches 60 °C (achieving temperature: 60 °C) can be used.

The pH at the end of the lactic acid bacteria treatment can be set as follows, according to the components of the milk fluid actually used.

(a) in the Case of a Milk Fluid that does not Contain Casein but Contains Whey Protein as a Milk-Derived Protein:

The pH at the end of lactic acid bacteria treatment is 5.2 to 6.5, preferably 5.6 to 6.5, more preferably 5.8 to 6.5, even more preferably 6.0 to 6.5, and particularly preferably 6.0 to 6.4.

When the pH at the end of the lactic acid bacteria treatment is 5.8 or higher, preferably 6.0 or higher, the resulting lactic acid bacteria-treated milk fluid does not taste sour and has a better flavor. The milk fluid here includes, for example, WPC and WPI.

### (b) in the Case of a Milk Fluid Containing Casein or Containing Casein and Whey Protein as a Milk-Derived Protein:

The pH at the end of lactic acid bacteria treatment is 6.0 to 6.5, preferably 6.0 to 6.4 or 6.1 to 6.5, and more preferably 6.1 to 6.4.

If the pH at the end of the lactic acid bacteria treatment is 6.0 or higher, the resulting lactic acid bacteria-treated milk fluid does not taste sour and has a better flavor.

The milk fluid here includes, for example, MPC, MPI, and MCC.

Adjusting the pH range at the end of the lactic acid bacteria treatment as described above according to the components of the milk fluid decreases milk-derived-protein odors, which is one of the effects of the present invention, thus providing a high-protein dairy material with good flavor.

Another characteristic is that those with a pH of 6.0 or higher, of these high-protein dairy materials, have little sourness (acidity). Thus, in order to obtain a high-protein dairy material that has a reduced milk-derived protein odors and reduced sourness, it is preferable to set the pH at the end of the lactic acid bacteria treatment to 6.0 or higher.

The method and equipment for treating the milk fluid with lactic acid bacteria may be known methods and equipment used in the fermentation treatment of starting-material milk. For example, the lactic acid bacteria treatment can be performed by using known methods and equipment used in the production of fermented milk products, such as yogurt.

The lactic acid bacteria-treated milk fluid thus prepared can be optionally subjected to a concentration step and/or a drying step to make the milk fluid into a semi-solid or solid form.

The concentration step is not particularly limited, and includes, for example, a method of subjecting a lactic acid bacteria-treated milk fluid to vacuum-evaporation concentration treatment (evaporation) or a dehydration (+desalting) treatment, such as reverse osmosis (RO) membrane treatment or nanofiltration (NF) membrane treatment, to obtain a semi-solid lactic acid bacteria-treated milk fluid with a total solids content of 20 to 50 mass %. The lactic acid bacteria-treated milk fluid obtained in the concentration step may be in a liquid form or a gel form. The total solids content in 100 mass % of the lactic acid bacteria-treated milk fluid is, for example, 20 to 50 mass %, preferably 20 to 40 mass %, more preferably 20 to 35 mass %, and even more preferably 20 to 30 mass %.

The drying step is not particularly limited, and examples include a method of subjecting a lactic acid bacteria-treated milk fluid or a semi-solid lactic acid bacteria-treated milk fluid after the concentration step to a dehydration treatment, such as spray drying treatment, freeze drying treatment, or drum drying treatment, to obtain a dry product (solid form) of the lactic acid bacteria-treated milk fluid having a moisture content of 2 to 5 mass %. The dry product of the lactic acid bacteria-treated milk fluid obtained in the drying step may be in the form of powder or particles, or may be in the form of granules obtained by regulating or granulating the powder or particles, or may be in the form of tablets obtained by tableting (compression-molding) the powder or particles.

### (II) Lactic Acid Bacteria-Treated High-Protein Dairy Material

The lactic acid bacteria-treated high-protein dairy material of the present invention is a liquid high-protein dairy material containing a milk-derived protein in an amount of 50 parts by mass or more per 100 parts by mass of the total solids content and contains at least killed lactic acid bacteria cells, diacetyl, and 3-hydroxy-2-butanone, with a pH within the range of 5.2 to 6.5. Preferably, the lactic acid bacteria-treated high-protein dairy material of the present invention is a material prepared (produced) according to the production method above.

As described above, the amount of the milk-derived protein per 100 parts by mass of the total solids content in the lactic acid bacteria-treated high-protein dairy material may be 50 parts by mass or more, and is preferably 60 parts by mass or more, more preferably 70 parts by mass or more, even more preferably 75 parts by mass or more, and particularly preferably 80 parts by mass or more. The upper limit is, but not limited to, for example, 95 parts by mass.

The pH of the lactic acid bacteria-treated high-protein dairy material can be set as follows, according to the components of the lactic acid bacteria-treated high-protein dairy material.

(a) in the Case of a Lactic Acid Bacteria-Treated High-Protein Dairy Material that does not Contain Casein but Contains Whey Protein as a Milk-Derived Protein:

The pH is 5.2 to 6.5, preferably 5.6 to 6.5, more preferably 5.8 to 6.5, even more preferably 6.0 to 6.5, and particularly preferably 6.0 to 6.4.

When the pH is 5.8 or higher, preferably 6.0 or higher, the lactic acid bacteria-treated milk fluid does not have a sour taste and has a better flavor. The lactic acid bacteria-treated high-protein dairy material here includes, for example, WPC and WPI.

### (b) in the Case of a Lactic Acid Bacteria-Treated High-Protein Dairy Material Containing Casein or Containing Casein and Whey Protein as a Milk-Derived Protein:

The pH is 6.0 to 6.5, preferably 6.0 to 6.4, or 6.1 to 6.5, more preferably 6.1 to 6.4.

When the pH is 6.0 or higher, the lactic acid bacteria-treated milk fluid does not have a sour taste and has a better flavor.

The lactic acid bacteria-treated high-protein dairy material here includes, for example, MPC, MPI, and MCC.

In other words, as described above, those with a pH of 6.0 or higher, of these lactic acid bacteria-treated high-protein dairy materials, have reduced milk-derived protein odors and a reduced sour taste.

Diacetyl and 3-hydroxy-2-butanone (“acetoin” below) are aroma components (indicator substance of fermentation aroma) that are produced, for example, when milk components are fermented with lactic acid bacteria. As shown in the Experimental Examples described below, treating a milk fluid with lactic acid bacteria was confirmed to have increased these aroma components. It is believed that due to the increase in these aroma components, the lactic acid bacteria-treated high-protein dairy material of the present invention has reduced milk-derived-protein odors and a better flavor compared with high-protein dairy materials that are not treated with lactic acid bacteria.

The proportion of diacetyl contained in the lactic acid bacteria-treated high-protein dairy material is not particularly limited, and can be 0.00001 to 0.001 mass % (0.1 to 10 ppm), preferably 0.00002 to 0.001 mass % (0.2 to 10 ppm), per 100 mass % of the total solids content of the lactic acid bacteria-treated high-protein dairy material. The proportion of acetoin contained in the lactic acid bacteria-treated high-protein dairy material is not particularly limited, and can be 0.00001 to 0.01 mass % (0.1 to 100 ppm), preferably 0.00002 to 0.01 mass % (0.2 to 100 ppm), per 100 mass % of the total solids content of the lactic acid bacteria-treated high-protein dairy material.

The aroma components can be analyzed based on the methods and operations described in the Experimental Examples below.

The proportion of diacetyl contained in the liquid lactic acid bacteria-treated high-protein dairy material is not particularly limited, and is, for example, 1 or more, preferably more than 1, more preferably 1.5 or more, even more preferably 1.5 to 10, even more preferably 1.5 to 9, and even more preferably 1.5 to 8, compared to the proportion of diacetyl contained in a high-protein dairy material produced according to the same formula and production method as the liquid lactic acid bacteria-treated high-protein dairy material except that it is not treated with lactic acid bacteria (defined as “1”).

The proportion of diacetyl contained in a solid lactic acid bacteria-treated high-protein dairy material is not particularly limited, and is, for example, 1 or more, preferably more than 1, more preferably 1.5 or more, even more preferably 1.5 to 10, even more preferably 1.5 to 9, and even more preferably 1.5 to 8, compared to the proportion of diacetyl contained in a high-protein dairy material produced according to the same formula and production method as the solid lactic acid bacteria-treated high-protein dairy material except that it is not treated with lactic acid bacteria (defined as “1”). The “proportion of diacetyl contained in a high-protein dairy material” can be determined from the value of the chart (peak) area corresponding to diacetyl in the headspace solid-phase microextraction of gas chromatography-mass spectrometry, as described in the Experimental Examples below (the same applies to the acetoin, dimethyl disulfide, dimethyl trisulfide, nonanal, and δ-decalactone below).

The proportion of acetoin contained in the liquid lactic acid bacteria-treated high-protein dairy material is not particularly limited, and is, for example, 1 or more, preferably more than 1, more preferably 1.5 or more, even more preferably 1.5 to 1000, even more preferably 1.5 to 900, and even more preferably 1.5 to 850, compared to the proportion of acetoin contained in a high-protein dairy material produced according to the same formula and production method as the liquid lactic acid bacteria-treated high-protein dairy material except that it is not treated with lactic acid bacteria (defined as “1”). The proportion of acetoin contained in the solid lactic acid bacteria-treated high-protein dairy material is not particularly limited, and is, for example, 1 or more, preferably more than 1, more preferably 1.5 or more, even more preferably 1.5 to 1000, even more preferably 1.5 to 900, and even more preferably 1.5 to 850, compared to the proportion of acetoin contained in a high-protein dairy material produced according to the same formula and production method as the solid lactic acid bacteria-treated high-protein dairy material except that it is not treated with lactic acid bacteria (defined as “1”).

Dimethyl disulfide (DMDS) and dimethyl trisulfide (DMTS) are aroma components that are produced, for example, when milk components containing proteins are heated (indicator substances for protein deterioration), and nonanal is an aroma component that is produced, for example, when milk components containing lipids are heated (indicator substance for lipid deterioration). As shown in the Experimental Examples described below, these aroma components were reduced by treating a milk fluid with lactic acid bacteria. Due to the reduction in these aroma components, or the reduction in these components combined with the increase in diacetyl and acetoin, the lactic acid bacteria-treated high-protein dairy material of the present invention has reduced milk-derived-protein odors compared to high-protein dairy materials that are not treated with lactic acid bacteria. Additionally, with the unpleasant flavor also reduced, the lactic acid bacteria-treated high-protein dairy material has a good flavor and a refreshing aftertaste.

The proportion of DMDS contained in the lactic acid bacteria-treated high-protein dairy material is not particularly limited, and can be 0.00000001 to 0.0000005 mass % (0.1 to 5 ppb), preferably 0.00000001 to 0.0000004 mass % (0.1 to 4 ppb), per 100 mass % of the total solids content of the lactic acid bacteria-treated high-protein dairy material. The proportion of DMTS contained in the lactic acid bacteria-treated high-protein dairy material is not particularly limited, and can be 0.000000004 to 0.0000005 mass % (0.04 to 5 ppb), preferably 0.000000004 to 0.0000004 mass % (0.04 to 4 ppb), per 100 mass % of the total solids content of the lactic acid bacteria-treated high-protein dairy material. Furthermore, the proportion of nonanal contained in the lactic acid bacteria-treated high-protein dairy material is not particularly limited, and can be 0.00000001 to 0.000001 mass % (0.1 to 10 ppb), preferably 0.00000001 to 0.0000009 mass % (0.1 to 9 ppb), per 100 mass % of the total solids content of the lactic acid bacteria-treated high-protein dairy material.

The aroma components can be analyzed according to the methods and operations described in the Experimental Examples below.

The proportion of DMDS contained in the liquid lactic acid bacteria-treated high-protein dairy material is not particularly limited, and is, for example, 1 or less, preferably less than 1, more preferably 0.9 or less, even more preferably 0.2 to 0.9, even more preferably 0.3 to 0.9, and even more preferably 0.3 to 0.8, compared to the proportion of DMDS contained in a high-protein dairy material produced according to the same formula and production method as the liquid lactic acid bacteria-treated high-protein dairy material except that it is not treated with lactic acid bacteria (defined as “1”). The proportion of DMDS contained in the solid lactic acid bacteria-treated high-protein dairy material is not particularly limited, and is, for example, 1 or less, preferably less than 1, more preferably 0.9 or less, even more preferably 0.2 to 0.9, even more preferably 0.3 to 0.9, and even more preferably 0.3 to 0.8, compared to the proportion of DMDS contained in a high-protein dairy material produced according to the same formula and production method as the solid lactic acid bacteria-treated high-protein dairy material except that it is not treated with lactic acid bacteria (defined as “1”).

The proportion of DMTS contained in the liquid lactic acid bacteria-treated high-protein dairy material is not particularly limited, and is, for example, 1 or less, preferably less than 1, more preferably 0.9 or less, even more preferably 0.2 to 0.9, even more preferably 0.3 to 0.9, and even more preferably 0.3 to 0.8, compared to the proportion of DMTS contained in a high-protein dairy material produced according to the same formula and production method as the liquid lactic acid bacteria-treated high-protein dairy material except that it is not treated with lactic acid bacteria (defined as “1”). The proportion of DMTS contained in the solid lactic acid bacteria-treated high-protein dairy material is not particularly limited, and is, for example, 1 or less, preferably less than 1, more preferably 0.9 or less, even more preferably 0.2 to 0.9, even more preferably 0.3 to 0.9, and even more preferably 0.3 to 0.8, compared to the proportion of DMTS contained in a high-protein dairy material produced according to the same formula and production method as the solid lactic acid bacteria-treated high-protein dairy material except that it is not treated with lactic acid bacteria (defined as “1”).

The proportion of nonanal contained in the liquid lactic acid bacteria-treated high-protein dairy material is not particularly limited, and is, for example, 1 or less, preferably less than 1, more preferably 0.9 or less, even more preferably 0.1 to 0.9, even more preferably 0.2 to 0.9, and even more preferably 0.3 to 0.9, compared to the proportion of nonanal contained in a high-protein dairy material produced according to the same formula and production method as the liquid lactic acid bacteria-treated high-protein dairy material except that it is not treated with lactic acid bacteria (defined as “1”). The proportion of nonanal contained in the solid lactic acid bacteria-treated high-protein dairy material is not particularly limited, and is, for example, 1 or less, preferably less than 1, more preferably 0.9 or less, even more preferably 0.1 to 0.9, even more preferably 0.2 to 0.9, and even more preferably 0.3 to 0.9, compared to the proportion of nonanal contained in a high-protein dairy material produced according to the same formula and production method as the solid lactic acid bacteria-treated high-protein dairy material except that it is not treated with lactic acid bacteria (defined as “1”).

δ-Decalactone is an indicator substance for milk flavor. As will be shown in the Experimental Examples described below, even treatment of a milk fluid with lactic acid bacteria hardly changed δ-decalactone. In other words, lactic acid bacteria-treated high-protein dairy materials contain δ-decalactone in an amount equivalent to that of high-protein dairy materials that are not treated with lactic acid bacteria. This indicates that lactic acid bacteria-treated high-protein dairy materials have the same dairy flavor as high-protein dairy materials that are not treated with lactic acid bacteria. In other words, the milk flavor is not significantly impaired by lactic acid bacteria treatment. The proportion of δ-decalactone contained in a lactic acid bacteria-treated high-protein dairy material is not particularly limited, but can be 0.00000001 to 0.0000005% (0.1 to 5 ppb), preferably 0.00000002 to 0.0000005% (0.2 to 5 ppb), per 100 mass % of the total solids content of the lactic acid bacteria-treated high-protein dairy material. The aroma components can be analyzed based on the methods and operations described in the Experimental Examples below.

The proportion of δ-decalactone contained in the liquid lactic acid bacteria-treated high-protein dairy material is not particularly limited, and is, for example, 0.7 to 1.3, preferably 0.7 to 1.2, more preferably 0.8 to 1.2, even more preferably 0.8 to 1.1, even more preferably 0.9 to 1.1, and even more preferably 0.9 to 1, compared to the proportion of δ-decalactone contained in a high-protein dairy material produced according to the same formula and production method as the liquid lactic acid bacteria-treated high-protein dairy material except that it is not treated with lactic acid bacteria (defined as “1”). The proportion of δ-decalactone contained in the solid lactic acid bacteria-treated high-protein dairy material is not particularly limited, and is, for example, 0.7 to 1.3, preferably 0.7 to 1.2, more preferably 0.8 to 1.2, even more preferably 0.8 to 1.1, even more preferably 0.9 to 1.1, and even more preferably 0.9 to 1, compared to the proportion of δ-decalactone contained in a high-protein dairy material produced according to the same formula and production method as the solid lactic acid bacteria-treated high-protein dairy material except that it is not treated with lactic acid bacteria (defined as “1”).

The lactic acid bacteria-treated high-protein dairy material of the present invention encompasses, but is not particularly limited to, those containing free amino acids at the concentrations shown below per kilogram of the total solids content of the lactic acid bacteria-treated high-protein dairy material.

(a) in the Case of a Lactic Acid Bacteria-Treated High-Protein Dairy Material that does not Contain Casein but Contains Whey Protein as a Milk-Derived Protein (Specifically, WPC or WPI):
Histidine (His): for example, 30 μmol/kg or more, preferably 30 to 1000 μmol/kg, more preferably 40 to 900 μmol/kg, and even more preferably 50 to 800 μmol/kg.
Asparagine (Asn): for example, 10 μmol/kg or more, preferably 10 to 300 μmol/kg, more preferably 10 to 250 μmol/kg, and even more preferably 15 to 200 μmol/kg.
Serine (Ser): for example, 30 μmol/kg or more, preferably 30 to 2500 μmol/kg, more preferably 40 to 2000 μmol/kg, and even more preferably 50 to 1500 μmol/kg.
Glutamine (Gln): for example, 10 μmol/kg or more, preferably 10 to 300 μmol/kg, more preferably 10 to 250 μmol/kg, and even more preferably 15 to 200 μmol/kg.
Glycine (Gly): for example, 100 μmol/kg or more, preferably 100 to 2500 μmol/kg, more preferably 100 to 2000 μmol/kg, and even more preferably 100 to 1500 μmol/kg.
Aspartic acid (Asp): for example, 30 μmol/kg or more, preferably 30 to 1000 μmol/kg, more preferably 40 to 900 μmol/kg, and even more preferably 50 to 800 μmol/kg.
Threonine (Thr): for example, 20 μmol/kg or more, preferably 20 to 1000 μmol/kg, more preferably 30 to 900 μmol/kg, and even more preferably 30 to 800 μmol/kg.
Alanine (Ala): for example, 80 μmol/kg or more, preferably 80 to 2000 μmol/kg, more preferably 100 to 1500 μmol/kg, and even more preferably 100 to 1000=mol/kg.
Proline (Pro): for example, 100 μmol/kg or more, preferably 100 to 2500 μmol/kg, more preferably 200 to 2500 μmol/kg, and even more preferably 200 to 2000 μmol/kg.
Lysine (Lys): for example, 200 μmol/kg or more, preferably 200 to 2500 μmol/kg, more preferably 300 to 2000 μmol/kg, and even more preferably 300 to 1500 μmol/kg.
Methionine (Met): for example, 10 μmol/kg or more, preferably 10 to 1000 μmol/kg, more preferably 10 to 800 μmol/kg, and even more preferably 15 to 600 μmol/kg.
Isoleucine (Ile): for example, 10 μmol/kg or more, preferably 10 to 1000 μmol/kg, more preferably 10 to 800 μmol/kg, and even more preferably 15 to 600 μmol/kg.
Valine (Val): for example, 30 μmol/kg or more, preferably 30 to 3000 μmol/kg, more preferably 40 to 2500 μmol/kg, and even more preferably 50 to 2000 μmol/kg.
Leucine (Leu): for example, 30 μmol/kg or more, preferably 30 to 1500 μmol/kg, more preferably 50 to 1200 μmol/kg, and even more preferably 80 to 1000 μmol/kg.

### (b) in the Case of a Lactic Acid Bacteria-Treated High-Protein Dairy Material Containing Casein or Containing Casein and Whey Protein as a Milk-Derived Protein (Specifically, MPC, MPI, and MCC):

Histidine (His): for example, 30 μmol/kg or more, preferably 30 to 1000 μmol/kg, more preferably 40 to 900 μmol/kg, and even more preferably 50 to 800 μmol/kg.
Asparagine (Asn): for example, 10 μmol/kg or more, preferably 10 to 300 μmol/kg, more preferably 10 to 250 μmol/kg, and even more preferably 15 to 200 μmol/kg.
Glutamine (Gln): for example, 10 μmol/kg or more, preferably 10 to 2000 μmol/kg, more preferably 30 to 1500 μmol/kg, and even more preferably 50 to 1000 μmol/kg.
Glycine (Gly): for example, 100 μmol/kg or more, preferably 100 to 2000 μmol/kg, more preferably 150 to 1500 μmol/kg, and even more preferably 150 to 1000 μmol/kg.
Arginine (Arg): for example, 50 μmol/kg or more, preferably 50 to 2000 μmol/kg, more preferably 60 to 1700 μmol/kg, and even more preferably 80 to 1500 μmol/kg.
Aspartic acid (Asp): for example, 40 μmol/kg or more, preferably 40 to 1000 μmol/kg, more preferably 50 to 900 μmol/kg, and even more preferably 60 to 800 μmol/kg.
Threonine (Thr): for example, 20 μmol/kg or more, preferably 20 to 600 μmol/kg, more preferably 30 to 500 μmol/kg, and even more preferably 30 to 400 μmol/kg.
Alanine (Ala): for example, 50 μmol/kg or more, preferably 50 to 2000 μmol/kg, more preferably 70 to 1700 μmol/kg, and even more preferably 100 to 1500 μmol/kg.
Proline (Pro): for example, 60 μmol/kg or more, preferably 60 to 2500 μmol/kg, more preferably 100 to 2000 μmol/kg, and even more preferably 150 to 2000 μmol/kg.
Lysine (Lys): for example, 50 μmol/kg or more, preferably 50 to 2000 μmol/kg, more preferably 70 to 1700 μmol/kg, and even more preferably 100 to 1500 μmol/kg.
Tyrosine (Tyr): for example, 20 μmol/kg or more, preferably 20 to 2000 μmol/kg, more preferably 25 to 1500 μmol/kg, and even more preferably 30 to 1000 μmol/kg.
Methionine (Met): for example, 5 μmol/kg or more, preferably 5 to 600 μmol/kg, more preferably 10 to 500 μmol/kg, and even more preferably 15 to 400 μmol/kg.
Isoleucine (Ile): for example, 20 μmol/kg or more, preferably 20 to 1000 μmol/kg, more preferably 25 to 800 μmol/kg, and even more preferably 30 to 600 μmol/kg.
Valine (Val): for example, 20 μmol/kg or more, preferably 20 to 2500 μmol/kg, more preferably 50 to 2000 μmol/kg, and even more preferably 80 to 1500 μmol/kg.
Leucine (Leu): for example, 20 μmol/kg or more, preferably 20 to 1500 μmol/kg, more preferably 50 to 1200 μmol/kg, and even more preferably 80 to 1000 μmol/kg.
Phenylalanine (Phe): for example, 20 μmol/kg or more, preferably 20 to 1000 μmol/kg, more preferably 25 to 800 μmol/kg, and even more preferably 30 to 600 μmol/kg.

These free amino acids can be analyzed according to the methods and operations described in the Experimental Examples below.

The lactic acid bacteria-treated high-protein dairy material covered by the present invention includes lactic acid bacteria-treated high-protein dairy materials prepared in a semi-solid or solid form by subjecting the liquid lactic acid bacteria-treated high-protein dairy material to concentration treatment and/or drying treatment.

The concentration treatment is not particularly limited, and includes, for example, a method of subjecting a lactic acid bacteria-treated milk fluid to vacuum-evaporation concentration treatment (evaporation) or a dehydration (+desalting) treatment, such as reverse osmosis (RO) membrane treatment or nanofiltration (NF) membrane treatment, to obtain a semi-solid lactic acid bacteria-treated milk fluid with a total solids content of 20 to 50 mass %. The lactic acid bacteria-treated milk fluid obtained in the concentration step may be in a liquid form or a semi-solid form (gel-like form). The total solids content is preferably 20 to 40 mass %, more preferably 20 to 35 mass %, and even more preferably 20 to 30 mass %.

The drying treatment is not particularly limited, and examples include a method of subjecting a lactic acid bacteria-treated milk fluid or a semi-solid lactic acid bacteria-treated milk fluid obtained in the concentration step to a dehydration treatment, such as spray drying treatment, freeze drying treatment, or drum drying treatment, to obtain a dry product of a solid lactic acid bacteria-treated milk fluid having a moisture content of 2 to 5 mass %. The dry product of the lactic acid bacteria-treated milk fluid obtained in the drying step may be in the form of powder or particles, or may be in the form of granules obtained by regulating or granulating the powder or particles, or may be in the form of tablets obtained by tableting (compression-molding) the powder or particles.

### (III) Food or Drink Product and Method for Producing Food or Drink Product

In an embodiment of the present invention, a method for producing a food or drink product, comprising the step of adding the lactic acid bacteria-treated high-protein dairy material produced according to the production method of the present invention to a food or drink product.

In addition to the lactic acid bacteria-treated high-protein dairy material produced according to the production method of the present invention, any components can be optionally blended (mixed) into the food or drink product. Such optional components are not particularly limited, but include components that are normally blended into food and drink products, such as aqueous raw materials, oil-based raw materials, saccharides, dietary fiber, polysaccharides, proteins, peptides, amino acids, lipids, organic acids, various physiologically active substances, vitamins, minerals, acidulants, flavorings, sweeteners, emulsifiers, thickeners, gelling agents, functional ingredients, oils and fats, excipients, coloring agents, preservatives, and water (hot water, warm water, room-temperature water, and cold water).

In a preferred embodiment of the present invention, there is provided a method for producing a food or drink product, comprising the step of mixing one, or two or more members selected from the group consisting of aqueous materials, oil-based materials, flavorings, sweeteners, emulsifiers, thickeners, gelling agents, functional ingredients, oils and fats, excipients, and water with a lactic acid bacteria-treated high-protein dairy material produced according to the production method of the present invention, and adding the mixture to a food or drink.

Examples of aqueous materials that can be contained in the food or drink product of the present invention include dairy materials other than the lactic acid bacteria-treated high-protein dairy material of the present invention (milk, skim milk, low-fat milk, ingredient-modified milk, etc.), dairy drinks, fermented milk, soy milk, fruit juice, vegetable juice, fruit/vegetable paste, fruit/vegetable extract, alcoholic drinks, and liquid sugar. Examples of oil-based materials that can be contained in the food or drink product of the present invention include butter, margarine, shortening, cream, chocolate, cacao mass, cocoa butter, and almond paste.

The food or drink product produced according to the production method of the present invention may be in any form, such as a solution, suspension, emulsion, powder, paste, semi-solid molded-product, or solid molded-product, as long as it is in a form that can be orally ingested.

Without any particular limitations, examples include instant foods, such as instant noodles, retort foods, canned foods, microwave foods, instant soups, including miso soups, and freeze-dried foods; drinks, such as soft drinks, fruit drinks, vegetable drinks, soy milk drinks, coffee drinks, tea drinks, powdered drinks, concentrated drinks, and alcoholic drinks; flour products, such as bread, pasta, noodles, cake mixes, and breadcrumbs; sweets, such as candy, caramel, gummy candy, chewing gum, chocolate, cookies, biscuits, bars, cakes, pies, snacks, crackers, Japanese sweets, puddings, jellies, mousses, dessert sweets, and iced sweets; condiments, such as sauces, tomato-processed seasonings, flavor seasonings, cooking mixes, topping sauces, dressings, dipping sauces, and curry and stew bases; oils and fats, such as processed oils and fats, butter, margarine, and mayonnaise; dairy products, such as milk drinks, fermented milk, lactic acid bacteria drinks, ice cream (ice cream, ice milk, lacto ice cream), and cream; agricultural processed products, such as canned agricultural products, jams, marmalades, and cereals; frozen foods, and liquid meals. Food or drink products also include health foods, functional foods (including, for example, foods for specified health uses, foods with nutrient function claims or foods with functional claims), nutritional supplements, foods for special dietary uses (including, for example, foods for the sick, infant formula, powdered milk for pregnant women and lactating women, or foods for people with swallowing difficulties), and infant liquid formula (also known as infant liquid milk). Of these, drinks, sweets, dairy products, and liquid foods are preferred, and fermented milk, milk drinks, coffee drinks, tea drinks, soft drinks, powdered drinks, liquid foods, ice cream (ice cream, ice milk, and lacto ice cream), iced sweets, and puddings are more preferred.

The method for producing a food or drink product of the present invention may be any production method as long as it includes the step of adding the lactic acid bacteria-treated high-protein dairy material of the present invention. For example, the food or drink product can be produced according to a commonly used method depending on the product.

Because the lactic acid bacteria-treated high-protein dairy material incorporated into the food or drink product of the present invention has reduced milk-derived-protein odors, the lactic acid bacteria-treated high-protein dairy material does not impair the original flavor of the food or drink and can enhance the protein content of the food or drink while maintaining a pleasant flavor. Thus, the present invention can provide a method for producing a food or drink that has reduced milk-derived-protein odors despite containing milk-derived protein.

The phrase “reduced milk-derived-protein odors” as used herein means that protein odors derived from a high-protein dairy material are reduced. Specifically, this means that using the lactic acid bacteria-treated high-protein dairy material of the present invention as a high-protein dairy material results in reduced protein odors derived from milk as compared to using a high-protein dairy material that is not treated with lactic acid bacteria. The phrase “protein odors” as used herein refers to protein odors (retronasally) felt in the region from the oral cavity to the nasal cavity. More objectively, reductions in milk-derived-protein odors can also be evaluated based on the fact that using the lactic acid bacteria-treated high-protein dairy material of the present invention as a high-protein dairy material results in decreases in DMDS and/or DMTS, which is an indicator substance for protein degradation, as compared to using a high-protein dairy material that is not treated with lactic acid bacteria. More objectively, reductions in milk-derived-protein odors can also be evaluated by using the following as indicators: using the lactic acid bacteria-treated high-protein dairy material of the present invention as a high-protein dairy material results in decreases in DMDS and/or DMTS as well as increases in diacetyl and/or acetoin, which are indicators of fermentation aroma, as compared to using a high-protein dairy material that is not treated with lactic acid bacteria.

Thus, the food or drink product obtained according to the production method of the present invention has reduced protein odors derived from a high-protein dairy material used as a dairy material. In other words, in an embodiment, the present invention provides a food or drink product with reduced protein odors derived from high-protein dairy materials by using a lactic acid bacteria-treated high-protein dairy material as a high-protein dairy material, as compared to by using a high-protein dairy material that is not treated with lactic acid bacteria. In a further preferred embodiment, the present invention provides a food or drink product with reduced unpleasant flavors and an improved refreshing taste by using a lactic acid bacteria-treated high-protein dairy material as a high-protein dairy material, as compared to by using a high-protein dairy material that is not treated with lactic acid bacteria. Such flavor improvement effects are thought to be achieved, for example, by the reduction in protein odors derived from the high-protein dairy material used as a dairy material.

### (IV) Method for Improving Flavor of High-Protein Dairy Material

The present invention relates to a method for improving the flavor of a high-protein dairy material, comprising the steps of:
(1) preparing a milk fluid from a dairy material having a total solids content of 5 to 15 mass % and a milk-derived protein content of 50 parts by mass or more per 100 parts by mass of the total solids content; and
(2) adding lactic acid bacteria to the milk fluid and maintaining the milk fluid containing the lactic acid bacteria until reaching a pH within the range of 5.2 to 6.5 to obtain a lactic acid bacteria-treated milk fluid having a pH within the range.

These steps (1) and (2) are as explained in section (I) above, and the descriptions in section (I) are incorporated herein by reference. Additionally, as described in section (I), the lactic acid bacteria-treated milk fluid may be subjected to pasteurization after step (1), and similarly, the lactic acid bacteria-treated milk fluid may be subjected to concentration treatment and/or drying treatment after step (2).

The phrase “improving flavor” includes at least the meaning of “reducing milk-derived-protein odors.” The phrase “reducing milk-derived-protein odors” means that protein odors derived from a high-protein dairy material are reduced. Specifically, this means that using the lactic acid bacteria-treated high-protein dairy material obtained by performing steps (1) and (2) above as a high-protein dairy material results in reduced protein odors as compared to using a high-protein dairy material that is not treated with lactic acid bacteria. The phrase “protein odors” as used herein refers to protein odors (retronasally) felt in the region from the oral cavity to the nasal cavity. More objectively, reductions in milk-derived-protein odors can also be evaluated based on the fact that using the lactic acid bacteria-treated high-protein dairy material of the present invention as a high-protein dairy material results in a decrease in DMDS and/or DMTS, which is an indicator substance for protein degradation, as compared to using a high-protein dairy material that is not treated with lactic acid bacteria. More objectively, reductions in milk-derived-protein odors can also be evaluated based on the following: using the lactic acid bacteria-treated high-protein dairy material of the present invention as a high-protein dairy material results in decreases in DMDS and/or DMTS as well as increases in diacetyl and/or acetoin, which are indicators of fermentation aroma, as compared to using a high-protein dairy material that is not treated with lactic acid bacteria

The phrase “improving flavor” preferably further includes the meaning of “refreshing aftertaste.” The phrase “refreshing aftertaste” also means that the unpleasant taste derived from a high-protein dairy material is reduced. Specifically, this means that using the lactic acid bacteria-treated high-protein dairy material obtained by performing steps (1) and (2) above as a high-protein dairy material leaves a refreshing aftertaste as compared with using a high-protein dairy material that is not treated with lactic acid bacteria. More objectively, the refreshing aftertaste can also be evaluated based on the following: using the lactic acid bacteria-treated high-protein dairy material of the present invention as a high-protein dairy material results in decreases in DMDS and/or DMTS as well as increases in diacetyl and/or acetoin, as compared to using a high-protein dairy material that is not treated with lactic acid bacteria.

In the present specification, the terms “comprise” and “contain” include the meanings of consisting of and consisting essentially of.

### EXAMPLES

The present invention is described with reference to Experimental Examples in order to help to understand the elements and effects of the invention. However, the present invention is not limited in any way by these Experimental Examples. Unless otherwise specified, the following experiments were performed at room temperature (25±5 °C) under atmospheric pressure (normal pressure). Unless otherwise specified, the unit “%” below means mass %, and the unit “parts” below means parts by mass.

The raw materials and lactic acid bacteria used in the Experimental Examples (Examples and Comparative Examples) described below are as follows.

Raw materials
Milk protein concentrate (MPC): MPC4850 (casein: 64%, whey: 16%), powder, Fonterra
Whey protein concentrate (WPC): WPC392 (whey: 80%), powder, Fonterra

### Lactic Acid Bacteria

(a) Lactobacillus bulgaricus (Lactobacillus delbrueckii subsp. bulgaricus) 1589 (NITE BP-03716) (“bulgaricus 1589” below). The bulgaricus 1589 was internationally deposited on Aug. 9, 2022 with the Patent Microorganisms Depositary of the National Institute of Technology and Evaluation, located at Room 122, 2-5-8 Kazusakamatari, Kisarazu, Chiba, under the identification designation “Lactobacillus delbrueckii subsp. bulgaricus 1589” (accession number: NITE BP-03716).
(b) Lactobacillus bulgaricus OLL 1073R-1 (FERM BP-10741) (“bulgaricus OLL 1073R-1” below) (high EPS (extracellular polysaccharide)-producing strain)

The bulgaricus OLL 1073R-1 was internationally deposited on Feb. 22, 1999 (domestic deposit date) with the International Patent Organism Depositary of the National Institute of Advanced Industrial Science and Technology, located at Chuo 6, 1-1-1 Higashi, Tsukuba, Ibaraki, Japan, under the identification designation “Lactobacillus delbrueckii subsp. bulgaricus OLL 1073R-1” (accession number: FERM BP-10741).

In April 2012, the Patent Organism Depositary of the National Institute of Advanced Industrial Science and Technology was integrated with the Patent Microorganisms Depositary of the National Institute of Technology and Evaluation (NITE), and the microbial depositary business is currently being performed by the Patent Microorganisms Depositary of the National Institute of Technology and Evaluation (NITE-IPOD) (Room 120, 2-5-8 Kazusakamatari, Kisarazu, Chiba, 292-0818, Japan).

(c) Streptococcus thermophilus (3078) (NITE BP-01697) (“thermophilus 3078” Below)

The thermophilus 3078 was internationally deposited with the Patent Microorganisms Depositary on Aug. 23, 2013 under the identification designation “Streptococcus thermophilus OLS3078” (accession number: NITE BP-01697).

(d) Lactobacillus casei P2203401 (“casei P2203401” Below)

In the Experimental Examples described below, aroma components and free amino acids were analyzed according to the following methods.

### Aroma Component Analysis

### (a) Analysis Method

Headspace solid-phase microextraction (HS-SPME) with gas chromatography-mass spectrometry (GC/MS)

### (b) Preparation of Analysis Samples

Liquid sample: put a liquid sample (3 mL) and saturated saline (5 mL) into a vial (20 mL) and mix them.

Powder sample: put a powder sample (0.3 g) and saturated saline (8 mL) into a vial (20 mL) and mix them.

### (c) Operating Conditions for Analysis

### Spme Fiber: Dvb/Car/Pdms (Merck)

Film thickness 50/30 μm
Extraction temperature and time: 60 °C and 40 minutes

### GC/MS Equipment: 7890GC/5977AMS (Agilent Technologies, Inc.)

Injection port temperature and mode: 250 °C, split injection 1:5
Carrier gas: helium, 1 mL/min
Column: DB-WAX-UI
0.25 mm×30 m, film thickness; 0.25 μm

### Oven: 40 °C and 5 Minutes→15 °C/Minutes→250 °C and 10 Minutes

Ion source temperature: 230 °C
Scan range: m/z 33-200

### Analysis of Free Amino Acids

### (a) Analysis Method: Ultra-Performance Liquid Chromatography-Mass Spectrometry (UPLC/MS/MS)

### (b) Preparation of Analysis Samples

Powder sample: prepare an aqueous solution of a powdered sample (10 mass %)

### (c) Operating Conditions for Analysis

### Uplc/Ms/Ms Instrument: Acuity Uplc-Msms (Tqd) (Waters)

Column: ACCQ-TAGTMULTPA C18, 1.7 mm, 2.1×100 mm
Oven: 55 °C
Sample injection volume: 10 μL
Solvent A: ACCQ TagUltraA is diluted 20-fold with ultrapure water and used.
Solvent B: ACCQ TagUltraB is used as is.
Strong: 100% CAN
Weak, Seal: 10% CAN in MilliQ

### UPLC Operating Conditions: Inlet Method

Flow Rate: 0.7 mL/min
0-2 min: 90% Diluent A, 2-10 min: 85% Diluent A, 10-12.5 min: 0%
Diluent A, 12.5-16 min: 90% Diluent A

### MS Analysis Conditions: MS Tune

MS Mode: MSMS (ESI+mode)
Capillary Voltage: 3.5 kV
Desolvation temperature: 350 °C
Desolvation gas (N2): 800 L/h
Cone gas (N2): 250 L/h
Collision gas (Ar): 0.15 mL/min (9 mL/h)

### MS Monitor:Monitoring Time 0-10 Min

HMB (mz/mz); 117.1>59.0, Cone Voltage 20V
Collision energy 10 eV, dwell 0.2s
HICA (mz/mz); 131.1>85.0, Cone Voltage 20V
Collision energy 10 eV, dwell 0.4s
2H2 MB(mz/mz); 117.1>71.0, Cone Voltage 20V
Collision energy 10 eV, dwell 0.2s

In the Experimental Examples described below, sensory evaluation was performed according to the following method.

### Sensory Evaluation

(a) Panel of Experts: Experts Who have Received in-House Sensory Evaluation Training and Who Regularly Conduct Sensory Evaluations in their Work (Sensory Evaluation Experts)

### (b) Sensory Evaluation Test

Each expert placed a test sample (a lactic acid bacteria-treated sample (invention sample) and a non-lactic acid bacteria-treated sample (control sample), which were both adjusted to room temperature (25±5 °C), in their mouth and swallowed it, and evaluated the protein odors (retronasally) felt in the region from the oral cavity to the nasal cavity and the refreshing aftertaste felt after swallowing the samples (reduction of unpleasant flavors). The invention sample was compared with the control sample to evaluate the difference (intensity) according to a pair comparison method. Details of the invention sample and control sample are described below.

For the evaluation of the protein odors and refreshing aftertaste, the experts individually examined the flavor (protein odor and aftertaste) of the control sample beforehand and discussed to unify the internal standards held by the panel.

Each expert scored the protein odors and refreshing aftertaste according to the criteria below, and the average was calculated to produce an overall evaluation.

### Protein Odors

3: Compared to the control sample, the protein odors are reduced.
2: Compared to the control sample, the protein odors are present to the same degree.
1: Compared to the control sample, the protein odors are increased.

### Refreshing Aftertaste

3: Compared to the control sample, there is no unpleasant aftertaste, and it feels very refreshing.
2: Compared to the control sample, the unpleasant aftertaste is present to the same degree.
1: Compared to the control sample, the unpleasant aftertaste is present, with a less refreshing taste.

### Experimental Example 1: Production and Evaluation of Liquid Lactic Acid Bacteria-treated High-protein Dairy Material Using MPC as a Dairy Material

### (1) Production of Liquid Lactic Acid Bacteria-Treated High-Protein Dairy Material

MPC was dissolved in warm water (60 °C) to prepare an MPC solution with a total solids content of 10 mass % (milk-derived protein content per 100 parts by mass of the total solids content: 80 parts by mass). This MPC solution was pasteurized (to 95 °C) and then cooled (40 °C) to prepare a pasteurized MPC solution. The lactic acid bacteria shown in Table 1 in a predetermined amount (10⁶ to 10⁸ cfu/ml) were mixed with this solution and stirred and maintained at the temperature and for the time shown in Table 1 to prepare a lactic acid bacteria-treated MPC solution with the pH shown in Table 1. None of these lactic acid bacteria-treated MPC solutions formed curd, and they were in a liquid form. Subsequently, these lactic acid bacteria-treated MPC solutions were heated (to 60 °C) and then cooled (10 °C or below) to produce liquid lactic acid bacteria-treated MPC (lactic acid bacteria-treated high-protein dairy materials). These products are referred below to as a “lactic acid bacteria-treated dairy material” (invention samples 1-a to 1-f).

TABLE 1

| Lactic Acid Bacteria- | | Treatment | Treatment | pH |
|---|---|---|---|---|
| treated Dairy Material | Lactic Acid Bacteria | Temperature | Time | Reached |
| Invention Sample 1-a | Bulgaricus 1589 | 38-40 °C | 165 min | 6.46 |
| | Thermophilus 3078 | | | |
| | (Ratio in Combination 1:1) | | | |
| Invention Sample 1-b | Bulgaricus 1589 | 38-40 °C | 245 min | 6.30 |
| | Thermophilus 3078 | | | |
| | (Ratio in Combination 1:1) | | | |
| Invention Sample 1-c | Bulgaricus 1589 | 39-41 °C | 210 min | 6.23 |
| | Thermophilus 3078 | | | |
| | (Ratio in Combination 1:1) | | | |
| Invention Sample 1-d | Bulgaricus OLL 1073R-1 | 38-40 °C | 180 min | 6.05 |
| Invention Sample 1-e | Bulgaricus OLL 1073R-1 | 39-41 °C | 180 min | 6.17 |
| Invention Sample 1-f | Casei P2203401 | 36-38 °C | 415 min | 6.42 |

### (2) Analysis of Aroma Component of Liquid Lactic Acid Bacteria-Treated High-Protein Dairy Material

According to the headspace solid-phase microextraction of gas chromatography-mass spectrometry described above, the aroma components of the lactic acid bacteria-treated dairy materials produced in Experimental Example 1 (1) (invention samples 1-a to 1-f) and a pasteurized MPC solution before lactic acid bacteria treatment (dairy material not treated with lactic acid bacteria) (control sample) were analyzed. The aroma components selected were dimethyl disulfide (DMDS) and dimethyl trisulfide (DMTS), which are sulfur compounds (both are indicator substances of protein deterioration), nonanal (indicator substance of lipid deterioration), diacetyl (indicator substance of fermentation aroma), acetoin (3-hydroxy-2-butanone) (indicator substance of fermentation aroma), and δ-decalactone (indicator substance of milky aroma).

The analytical value (area value in a chart) of each aroma component of the control sample was set to 1.0, and the analytical values of the aroma components of the lactic acid bacteria-treated dairy materials (invention samples 1-a to 1-f) were calculated as relative values. Table 2 shows the results.

TABLE 2

| Relative | | | | | | δ- |
|---|---|---|---|---|---|---|
| Value | | | | | | Deca- |
| [—] | DMDS | DMTS | Diacetyl | Acetoin | Nonanal | lactone |
| Control | 1.0 | 1.0 | 1.0 | 1.0 | 1.0 | 1.0 |
| Sample | | | | | | |
| Invention | 0.4 | 0.5 | 4.4 | 335 | 0.6 | 1.0 |
| Sample 1-a | | | | | | |
| Invention | 0.5 | 0.4 | 6.5 | 690 | 0.6 | 0.9 |
| Sample 1-b | | | | | | |
| Invention | 0.5 | 0.7 | 6.7 | 833 | 0.3 | 1.0 |
| Sample 1-c | | | | | | |
| Invention | 0.6 | 0.5 | 1.0 | 3.7 | 0.5 | 1.1 |
| Sample 1-d | | | | | | |
| Invention | 0.3 | 0.6 | 1.0 | 2.4 | 0.5 | 1.1 |
| Sample 1-e | | | | | | |
| Invention | 0.6 | 0.7 | 0.9 | 1.7 | 0.4 | 1.0 |
| Sample 1-f | | | | | | |

As shown in Table 2, the liquid lactic acid bacteria-treated dairy materials (invention samples 1-a to 1-f) tended to have decreased levels of DMDS and DMTS, which are protein degradation indicator substances, and a decreased level of nonanal, which is a lipid degradation indicator substance, as compared to the liquid dairy material not treated with lactic acid bacteria (control sample). Invention samples 1-a to 1-f tended to have increased levels of diacetyl and acetoin, which are fermentation aroma indicator substances, as compared to the control sample. Additionally, invention samples 1-a to 1-f tended to show almost no change in the level of 6-decalactone, as compared to the control sample.

### (3) Sensory Evaluation of Liquid Lactic Acid Bacteria-Treated High-Protein Dairy Material

A panel of five experts evaluated the protein odors and refreshing aftertaste of the lactic acid bacteria-treated dairy materials (invention samples 1-a to 1-f) produced in Experimental Example 1 (1) according to the method described above. Table 3 shows the average scores of the five experts of the panel.

TABLE 3
The Average Scores of the Five Experts of the Panel

| Liquid Lactic Acid | | |
|---|---|---|
| Bacteria-treated | Protein | Refreshing |
| Dairy Material | Odor | Aftertaste |
| Invention Sample 1-a | 3 | 3 |
| Invention Sample 1-b | 3 | 3 |
| Invention Sample 1-c | 3 | 3 |
| Invention Sample 1-d | 3 | 3 |
| Invention Sample 1-e | 3 | 3 |
| Invention Sample 1-f | 2.6 | 2.6 |

As shown in Table 3, the liquid lactic acid bacteria-treated dairy materials (invention samples 1-a to 1-f) were confirmed to have decreased levels of protein odors and have a refreshing aftertaste as compared to the liquid dairy material not treated with lactic acid bacteria (control sample). Moreover, none of invention samples 1-a to 1-f had a sour taste.

It can be inferred from the results shown in Table 2 that the reductions in DMDS and DMTS, which are among the causes of protein odors, and the increases in diacetyl and acetoin led to a masking effect, reducing the protein odors and providing a refreshing aftertaste.

### Experimental Example 2: Production and Evaluation of Powdered Lactic Acid Bacteria-Treated High-Protein Dairy Material Using MPC as a Dairy Material

### (1) Production of Powdered Lactic Acid Bacteria-Treated High-Protein Dairy Material

Of the liquid lactic acid bacteria-treated MPC (lactic acid bacteria-treated high-protein dairy materials) produced in Experimental Example 1 (1), invention samples 1-a and 1-b, as well as a pasteurized MPC solution before lactic acid bacteria treatment (dairy material not treated with lactic acid bacteria, control sample), were spray-dried (inlet air temperature: 180 to 185 °C, exhaust air temperature: 80 to 85 °C) using a spray dryer, thereby producing (solid) powdered lactic acid bacteria-treated MPC (lactic acid bacteria-treated high-protein dairy materials, invention samples 2-a and 2-b) and powdered MPC not treated with lactic acid bacteria (control sample). These products are referred below to as “powdered lactic acid bacteria-treated dairy materials” (invention samples 2-a and 2-b) and “powdered dairy material not treated with lactic acid bacteria” (control sample).

### (2) Analysis of Aroma Components of Powdered Lactic Acid Bacteria-Treated Dairy Material

The powdered lactic acid bacteria-treated dairy materials produced in Experimental Example 2 (1) (invention samples 2-a and 2-b) and a powdered dairy material not treated with lactic acid bacteria (control sample) were analyzed for aroma components according to the headspace solid-phase microextraction of gas chromatography-mass spectrometry described above in the same manner as in Experimental Example 1 (2). The analytical value (area value in a chart) of each aroma component of the control sample was set to 1.0, and the analytical values of the aroma components of invention samples 2-a and 2-b were calculated as relative values. Table 4 shows the results.

TABLE 4

| Relative | | | | | | δ- |
|---|---|---|---|---|---|---|
| Value | | | | | | Deca- |
| [—] | DMDS | DMTS | Diacetyl | Acetoin | Nonanal | lactone |
| Control | 1.0 | 1.0 | 1.0 | 1.0 | 1.0 | 1.0 |
| Sample | | | | | | |
| Invention | 0.5 | 0.6 | 4.6 | 160 | 1.0 | 1.0 |
| Sample 2-a | | | | | | |
| Invention | 0.6 | 0.7 | 6.3 | 329 | 0.9 | 1.0 |
| Sample 2-b | | | | | | |

As shown in Table 4, the powdered lactic acid bacteria-treated dairy materials (invention samples 2-a and 2-b) tended to have decreased levels of DMDS and DMTS, which are protein degradation indicator substances, as compared to the powdered dairy material not treated with lactic acid bacteria (control sample). Invention samples 2-a and 2-b tended to have increased levels of diacetyl and acetoin, as compared to the control sample. Additionally, invention samples 2-a and 2-b tended to show almost no change in the level of nonanal and δ-decalactone, as compared to the control sample.

The results of Experimental Example 1 (2) and Experimental Example 2 (2) indicate that treatment of high-protein dairy materials with lactic acid bacteria tended to reduce the levels of DMDS and DMTS, which are protein degradation indicator substances, and tended to increase the levels of diacetyl and acetoin, which are fermentation odor indicator substances. Additionally, it was also confirmed that drying these liquid samples to prepare (solid) powder samples did not affect the tendency for DMDS and DMTS to decrease and for diacetyl and acetoin to increase.

### (3) Analysis of Free Amino Acids in Powdered Lactic Acid Bacteria-Treated Dairy Materials

According to the ultra-performance liquid chromatography-mass spectrometry described above, the powdered lactic acid bacteria-treated dairy materials (invention samples 2-a and 2-b) produced in Experimental Example 2 (1) and the powdered dairy material not treated with lactic acid bacteria (control sample) were analyzed for free amino acids (histidine (His), asparagine (Asn), serine (Ser), glutamine (Gln), glycine (Gly), arginine (Arg), aspartic acid (Asp), glutamic acid (Glu), threonine (Thr), alanine (Ala), proline (Pro), lysine (Lys), cysteine (Cys), tyrosine (Tyr), methionine (Met), isoleucine (Ile), valine (Val), leucine (Leu), phenylalanine (Phe), tryptophan (Trp), citrulline (Cit), γ-aminobutyric acid (GABA), and ornithine (Orn)). Tables 5-1 to 5-4 show the results.

TABLE 5-1

| Concentration [μmol/kg] | His | Asn | Ser | Gln | Gly | Arg |
|---|---|---|---|---|---|---|
| Control Sample | 20 | 6.6 | 94 | 5.0 | 90 | 30 |
| Invention Sample 2-a | 78 | 11 | 50 | 62 | 191 | 86 |
| Invention Sample 2-b | 163 | 29 | 155 | 150 | 205 | 199 |

TABLE 5-2

| Concentration [μmol/kg] | Asp | Glu | Thr | Ala | Pro | Lys |
|---|---|---|---|---|---|---|
| Control Sample | 27 | 142 | 19 | 41 | 14 | 27 |
| Invention Sample 2-a | 65 | 119 | 32 | 119 | 192 | 126 |
| Invention Sample 2-b | 248 | 250 | 68 | 255 | 459 | 307 |

TABLE 5-3

| Concentration [μmol/kg] | Cys | Tyr | Met | Ile | Val | Leu |
|---|---|---|---|---|---|---|
| Control Sample | 0.0 | 12 | 1.7 | 14 | 18 | 16 |
| Invention Sample 2-a | 0.2 | 35 | 26 | 35 | 92 | 95 |
| Invention Sample 2-b | 0.5 | 125 | 82 | 107 | 271 | 261 |

TABLE 5-4

| Concentration [μmol/kg] | Phe | Trp | Cit | Gaba |
|---|---|---|---|---|
| Control Sample | 9.8 | 4.9 | 2.1 | 0.8 |
| Invention Sample 2-a | 41 | 15 | 1.9 | 1.0 |
| Invention Sample 2-b | 119 | 39 | 1.9 | 0.8 |

As shown in Tables 5-1 to 5-4, it was confirmed that the powdered lactic acid bacteria-treated dairy materials (invention samples 2-a and 2-b) generally had increased amounts of free amino acids compared to the powdered dairy material that was not treated with lactic acid bacteria (control sample).

### (4) Sensory Evaluation of Powdered Lactic Acid Bacteria-Treated Dairy Material

The powdered lactic acid bacteria-treated dairy materials (invention samples 2-a and 2-b) produced in section (1) above and the control sample were prepared into aqueous solutions so that the total solids content in each solution was 10 mass %. A panel of five experts evaluated these aqueous solutions for protein odors and refreshing aftertaste of invention samples 2-a and 2-b by using a pair comparison method with the control sample according to the method described above. Table 6 shows the average scores of the five experts of the panel.

TABLE 6
The Average Scores of the Five Experts of the Panel

| Powdered Lactic Acid | | |
|---|---|---|
| Bacteria-treated | Protein | Refreshing |
| Dairy Material | Odor | Aftertaste |
| Invention Sample 2-a | 3 | 3 |
| Invention Sample 2-b | 3 | 3 |

As shown in Table 6, the powdered lactic acid bacteria-treated dairy materials (invention samples 2-a and 2-b) were confirmed to have reduced levels of protein odors and have a refreshing aftertaste as compared to the powdered dairy material not treated with lactic acid bacteria (control sample). Moreover, neither of invention samples 2-a and 2-b had a sour taste.

It can be inferred from the results shown in Table 4 that the reductions in DMDS and DMTS, which are among the causes of protein odors, and the increases in diacetyl and acetoin led to a masking effect, reducing the protein odors and providing a refreshing aftertaste.

### Experimental Example 3: Production and Evaluation of Liquid Lactic Acid Bacteria-Treated High-Protein Dairy Material Using WPC as Dairy Material

### (1) Production of Liquid Lactic Acid Bacteria-Treated High-Protein Dairy Material

WPC was dissolved in warm water (60 °C) to prepare a WPC solution with a total solids content of 10 mass %, (milk-derived protein content per 100 parts by mass of the total solids content: 80 parts by mass). This WPC solution was pasteurized (to 70 °C) and then cooled (40 °C) to prepare a pasteurized WPC solution. The lactic acid bacteria shown in Table 7 in a predetermined amount (10⁶ to 10⁸ cfu/ml) were mixed with this solution and stirred and maintained at the temperature and for the time shown in Table 7 to prepare a lactic acid bacteria-treated WPC solution with the pH shown in Table 7. None of these lactic acid bacteria-treated WPC solutions formed curd, and they were in a liquid form. Subsequently, these lactic acid bacteria-treated WPC solutions were heated (to 60 °C) and then cooled (10 °C or below) to produce liquid lactic acid bacteria-treated WPC (lactic acid bacteria-treated high-protein dairy material). These products are referred below to as a “lactic acid bacteria-treated dairy material” (invention samples 3-a to 3-f).

TABLE 7

| Lactic Acid | | | | |
|---|---|---|---|---|
| Bacteria-treated | | Treatment | Treatment | |
| Dairy Material | Lactic Acid Bacteria | Temperature | Time | pH Reached |
| Invention Sample 3-a | Bulgaricus 1589 | 38-40 °C | 200 min | 6.12 |
| | Thermophilus 3078 | | | |
| Invention Sample 3-b | Bulgaricus 1589 | 38-40 °C | 320 min | 5.36 |
| | Thermophilus 3078 | | | |
| | (Ratio in Combination 1:1) | | | |
| Invention Sample 3-c | Bulgaricus 1589 | 39-41 °C | 190 min | 6.10 |
| | Thermophilus 3078 | | | |
| | (Ratio in Combination 1:1) | | | |
| Invention Sample 3-d | Bulgaricus OLL 1073R-1 | 38-40 °C | 360 min | 5.55 |
| Invention Sample 3-e | Bulgaricus OLL 1073R-1 | 39-41 °C | 215 min | 6.17 |
| Invention Sample 3-f | Casei P2203401 | 36-38 °C | 335 min | 6.36 |

### (2) Analysis of Aroma Component of Liquid Lactic Acid Bacteria-Treated Dairy Material

According to the headspace solid-phase microextraction of gas chromatography-mass spectrometry described above, the aroma components of the lactic acid bacteria-treated dairy materials produced in Experimental Example 3 (1) (invention samples 3-a to 3-f) and a pasteurized WPC solution before lactic acid bacteria treatment (dairy material not treated with lactic acid bacteria) (control sample) were analyzed in the same manner as in Experimental Example 1 (2). As in Experimental Example 1 (2), the following aroma components were selected: DMDS and DMTS (both are indicator substances of protein deterioration), nonanal (indicator substance of lipid deterioration), diacetyl (indicator substance of fermentation aroma), acetoin an indicator of fermentation aroma), and δ-decalactone (indicator substance of milky aroma).

The analytical value (area value in a chart) of each aroma component of the control sample was set to 1.0, and the analytical values of the aroma components of invention samples 3-a to 3-f were calculated as relative values. Table 8 shows the results.

TABLE 8

| Relative | | | | | | δ- |
|---|---|---|---|---|---|---|
| Value | | | | | | Deca- |
| [—] | DMDS | DMTS | Diacetyl | Acetoin | Nonanal | lactone |
| Control | 1.0 | 1.0 | 1.0 | 1.0 | 1.0 | 1.0 |
| Sample | | | | | | |
| Invention | 0.4 | 0.5 | 2.6 | 121 | 0.6 | 1.2 |
| Sample 3-a | | | | | | |
| Invention | 0.4 | 0.6 | 2.5 | 163 | 0.3 | 1.1 |
| Sample 3-b | | | | | | |
| Invention | 0.3 | 0.4 | 2.2 | 101 | 1.0 | 0.8 |
| Sample 3-c | | | | | | |
| Invention | 0.7 | 0.7 | 0.8 | 2.1 | 0.5 | 1.2 |
| Sample 3-d | | | | | | |
| Invention | 0.6 | 0.8 | 2.0 | 95 | 0.7 | 0.7 |
| Sample 3-e | | | | | | |
| Invention | 0.9 | 0.6 | 0.9 | 1.3 | 0.8 | 0.7 |
| Sample 3-f | | | | | | |

As shown in Table 8, the liquid lactic acid bacteria-treated dairy materials (invention samples 3-a to 3-f) tended to have decreased levels of DMDS and DMTS, which are protein degradation indicator substances, and a decreased level of nonanal, which is a lipid degradation indicator substance, as compared to the liquid dairy material not treated with lactic acid bacteria (control sample). Invention samples 3-a to 3-f tended to have increased levels of diacetyl and/or acetoin, which are indicator substances of fermentation aroma, as compared to the control sample. Additionally, invention samples 3-a to 3-f tended to show almost no change in the level of δ-decalactone, as compared to the control sample.

### (3) Sensory Evaluation of Liquid Lactic Acid Bacteria-Treated Dairy Material

In the same manner as in Experimental Example 1 (3), a panel of five experts evaluated the protein odors and refreshing aftertaste of invention samples 3a to 3f according to a pair comparison method with the control sample. Table 9 shows the average scores of the five experts of the panel.

TABLE 9
The Average Scores of the Five Experts of the Panel

| Lactic Acid | | |
|---|---|---|
| Bacteria-treated | Protein | Refreshing |
| Dairy Material | Odor | Aftertaste |
| Invention Sample 3-a | 3 | 3 |
| Invention Sample 3-b | 3 | 3 |
| Invention Sample 3-c | 3 | 3 |
| Invention Sample 3-d | 3 | 3 |
| Invention Sample 3-e | 3 | 3 |
| Invention Sample 3-f | 3 | 3 |

As shown in Table 9, the liquid lactic acid bacteria-treated dairy materials (invention samples 3-a to 3-f) were confirmed to have decreased levels of protein odors and have a refreshing aftertaste as compared to the liquid dairy material not treated with lactic acid bacteria (control sample). Moreover, invention samples 3-a, 3-c, 3-e and 3-f did not have a sour taste, while invention samples 3-b and 3-d had a slight sour taste.

It can be inferred from the results shown in Table 8 that the reductions in DMDS and DMTS, which are among the causes of protein odors, and the increases in diacetyl and acetoin led to a masking effect, reducing the protein odors and providing a refreshing aftertaste. It was also confirmed that when the pH after lactic acid bacteria treatment was 6 or higher, the sour taste was not perceived, whereas when the pH was lower than 6, the sour taste became noticeable.

### Experimental Example 4: Production and Evaluation of Powdered Lactic Acid Bacteria-Treated High-Protein Dairy Material Using WPC as Dairy Material

### (1) Production of Powdered Lactic Acid Bacteria-Treated High-Protein Dairy Material

Of the liquid lactic acid bacteria-treated dairy materials (invention samples 3-a to 3-f) produced in Experimental Example 3 (1), invention sample 3-a and a pasteurized WPC solution before lactic acid bacteria treatment (dairy material not treated with lactic acid bacteria, control sample), were spray-dried (inlet air temperature: 180 to 185 °C, exhaust air temperature: 80 to 85 °C) using a spray dryer, thereby producing (solid) powdered lactic acid bacteria-treated WPC (lactic acid bacteria-treated high-protein dairy material, invention sample 4-a) and powdered dairy material not treated with lactic acid bacteria (control sample). These products are each referred below to as a “powdered lactic acid bacteria-treated dairy material” (invention sample 4-a) and a “powdered dairy material not treated with lactic acid bacteria” (control sample).

### (2) Analysis of Aroma Components of Powdered Lactic Acid Bacteria-Treated Dairy Material

The powdered lactic acid bacteria-treated dairy material produced in Experimental Example 4 (1) (invention sample 4-a) and the powdered dairy material not treated with lactic acid bacteria (control sample) were prepared into aqueous solutions so that the total solids content in each solution was 10 mass %. In the same manner as in Experimental Example 1 (2), the aroma components of these aqueous solutions were analyzed according to the headspace solid-phase microextraction of gas chromatography-mass spectrometry described above.

The analytical value (area value in a chart) of each aroma component of the control sample was set to 1.0, and the analytical values of the aroma components of invention sample 4-a were calculated as relative values. Table 10 shows the results.

TABLE 10

| Relative | | | | | | δ- |
|---|---|---|---|---|---|---|
| Value | | | | | | Deca- |
| [—] | DMDS | DMTS | Diacetyl | Acetoin | Nonanal | lactone |
| Control Sample | 1.0 | 1.0 | 1.0 | 1.0 | 1.0 | 1.0 |
| Invention | 0.9 | 0.9 | 2.8 | 47 | 1.2 | 1.2 |
| Sample 4-a | | | | | | |

As shown in Table 10, the powdered lactic acid bacteria-treated dairy material (invention sample 4-a) tended to have reduced levels of DMDS and DMTS, which are protein degradation indicator substances, as compared to the dairy material not treated with lactic acid bacteria (control sample). Invention sample 4-a tended to have increased levels of diacetyl and acetoin as compared to the control sample. Additionally, invention sample 4-a showed almost no change in the level of 6-decalactone, as compared to the control sample.

The results of Experimental Example 3 (2) and Experimental Example 4 (2) indicate that treatment of high-protein dairy materials with lactic acid bacteria tended to reduce the levels of DMDS and DMTS, which are protein degradation indicator substances, and tended to increase the levels of diacetyl and acetoin, which are fermentation odor indicator substances. Additionally, it was confirmed that drying these liquid samples to prepare (solid) powder samples did not significantly affect the tendency for DMDS and DMTS to decrease and for diacetyl and acetoin to increase.

### (3) Analysis of Free Amino Acids in Powdered Lactic Acid Bacteria-Treated Dairy Material

According to the ultra-high performance liquid chromatography-mass spectrometry, invention sample 4-a produced in Experimental Example 4 (1) and the control sample were analyzed for free amino acids (histidine (His), asparagine (Asn), serine (Ser), glutamine (Gln), glycine (Gly), arginine (Arg), aspartic acid (Asp), glutamic acid (Glu), threonine (Thr), alanine (Ala), proline (Pro), lysine (Lys), cysteine (Cys), tyrosine (Tyr), methionine (Met), isoleucine (Ile), valine (Val), leucine (Leu), phenylalanine (Phe), tryptophan (Trp), citrulline (Cit), and γ-aminobutyric acid (GABA)). Tables 11-1 to 11-4 show the results.

TABLE 11-1

| Concentration [μmol/kg] | His | Asn | Ser | Gln | Gly | Arg |
|---|---|---|---|---|---|---|
| Control Sample | 19 | 2.1 | 15 | 1.2 | 78 | 85 |
| Invention Sample 4-a | 181 | 27 | 65 | 98 | 114 | 116 |

TABLE 11-2

| Concentration [μmol/kg] | Asp | Glu | Thr | Ala | Pro | Lys |
|---|---|---|---|---|---|---|
| Control Sample | 18 | 74 | 5.6 | 44 | 53 | 145 |
| Invention Sample 4-a | 61 | 92 | 68 | 135 | 468 | 434 |

TABLE 11-3

| Concentration [μmol/kg] | Cys | Tyr | Met | Ile | Val | Leu |
|---|---|---|---|---|---|---|
| Control Sample | 0.7 | 23 | 3.6 | 2.5 | 13 | 12 |
| Invention Sample 4-a | 0.0 | 19 | 21 | 38 | 157 | 90 |

TABLE 11-4

| Concentration [μmol/kg] | Phe | Trp | Cit | Gaba |
|---|---|---|---|---|
| Control Sample | 27 | 5.5 | 2.3 | 0.6 |
| Invention Sample 4-a | 22 | 1.3 | 2.1 | 0.4 |

As shown in Tables 11-1 to 11-4, it was confirmed that the powdered lactic acid bacteria-treated dairy material (invention sample 4-a) generally had increased amounts of free amino acids compared to the powdered dairy material that was not treated with lactic acid bacteria (control sample).

### (4) Sensory Evaluation of Powdered Lactic Acid Bacteria-Treated Dairy Material

The powdered lactic acid bacteria-treated dairy material (invention sample 4a) produced in section (1) above and the control sample were prepared into aqueous solutions so that the total solids content in each solution was 10 mass %. A panel of five experts evaluated the protein odors and refreshing aftertaste of invention sample 4-a using these aqueous solutions using a pair comparison method with the control sample according to the method described above. Table 12 shows the average scores of the five experts of the panel.

TABLE 12
The Average Scores of the Five Experts of the Panel

| Powdered Lactic Acid | | |
|---|---|---|
| Bacteria-treated | Protein | Refreshing |
| Dairy Material | Odor | Aftertaste |
| Invention Sample 4-a | 3 | 3 |

As shown in Table 12, the powdered lactic acid bacteria-treated dairy material (invention sample 4-a) had reduced levels of protein odors and had a refreshing aftertaste as compared to the powdered dairy material not treated with lactic acid bacteria (control sample). Moreover, invention sample 4-a had almost no sour taste.

It can be inferred from the results shown in Table 10 that the reductions in DMDS and DMTS, which are among the causes of protein odors, and the increases in diacetyl and acetoin led to a masking effect, reducing the protein odors and providing a refreshing aftertaste.

### Experimental Example 5: Production and Evaluation of High-Protein Milk Drink Containing Powdered Lactic Acid Bacteria-Treated Dairy Material

### (1) Production of High-Protein Milk Drink

High-protein milk drinks (invention drink and control drink) were produced by adding the powdered lactic acid bacteria-treated dairy material produced in Experimental Example 2 (invention sample 2-a) or a powdered dairy material not treated with lactic acid bacteria (control sample). Specifically, the invention drink and the control drink were produced as described below.

### (1-1) Production of Invention Drink

Invention sample 2-a and concentrated skim milk (total solids content: about 30 mass %) were mixed such that the protein content was about 8 mass %, thereby preparing a preparation liquid. Subsequently, baking soda (sodium bicarbonate) was added to this preparation liquid, and the pH was adjusted (pH=6.7) so that the preparation liquid had the same pH as that of the control drink described below. The preparation liquid was then heated (65 °C) and homogenized (first-stage pressure: 10 MPa, second-stage pressure: 5 MPa), and then pasteurized (to 90 °C), followed by cooling (10 °C or below), thereby producing the invention drink (protein content: 8 mass %).

### (1-2) Production of Control Drink

The control sample and concentrated skim milk (total solids content: about 30 mass %) were mixed such that the total protein content was about 8 mass %, thereby preparing a preparation liquid. The preparation liquid was then heated (65 °C) and homogenized (first-stage pressure: 10 MPa, second-stage pressure: 5 MPa), and then pasteurized (to 90 °C), followed by cooling (10 °C or below), thereby producing a control drink (protein content: 8 mass %).

### (2) Sensory Evaluation of Invention Drink

A panel of 15 experts evaluated the protein odors, refreshing feeling (refreshing aftertaste), fresh milk aroma, and heated milk aroma of the invention drink according to a pair comparison method with the control drink.

The phrase “fresh milk aroma” refers to the original milk flavor that can be felt from unheated (unpasteurized) milk (raw milk). Additionally, the phrase “heated milk aroma” refers to a burnt flavor that is detected in heated (pasteurized) milk. The experts of the panel confirmed these flavors beforehand and discussed to unify their internal standards. According to the criteria below, each expert scored the protein odors, refreshing feeling (refreshing aftertaste), fresh milk aroma, and heated milk aroma; then, the average scores were calculated to determine an overall evaluation.

### Protein Odor

3: Compared to the control sample, the protein odors are reduced.
2: Compared to the control sample, the protein odors are present to the same extent.
1: Compared to the control sample, the protein odors are increased.

### Refreshing Aftertaste

3: Compared to the control sample, there is no unpleasant aftertaste, and it feels very refreshing.
2: Compared to the control sample, the unpleasant aftertaste is present to the same degree.
1: Compared to the control sample, the unpleasant aftertaste is present, with a less refreshing taste.

### Fresh Milk Aroma

3: Compared to the control sample, the fresh milk aroma is strong.
2: Compared to the control sample, the fresh milk aroma is present to the same degree.
1: Compared to the control sample, the fresh milk aroma is faint.

### Heated Milk Aroma

3: Compared to the control sample, the heated milk aroma is faint.
2: Compared to the control sample, the heated milk aroma is present to the same degree.
1: Compared to the control sample, the heated milk aroma is strong.

TABLE 13
The Average Scores of the 15 Experts of the Panel

| Lactic Acid | | | Fresh | Heated |
|---|---|---|---|---|
| Bacteria-treated | Protein | Refreshing | Milk | Milk |
| Milk Drink | Odor | Aftertaste | Aroma | Aroma |
| Invention Drink | 2.5 | 2.1 | 2.3 | 2.4 |

As shown in Table 13, the invention drink had a reduced level of protein odors, with a refreshing aftertaste, a strong fresh milk aroma, and a reduced heated milk aroma compared to the control sample.

1. A method for producing a high-protein dairy material comprising the steps of
(1) preparing a milk fluid from a dairy material, the milk fluid having a total solids content of 5 to 15 mass % and containing a milk-derived protein in an amount of 50 parts by mass or more per 100 parts by mass of the total solids content, and
(2) adding lactic acid bacteria to the milk fluid and maintaining the milk fluid containing the lactic acid bacteria until achieving a pH within a range of 5.2 to 6.5 to obtain a lactic acid bacteria-treated milk fluid with a pH within the range.

2. The method according to claim 1, further comprising the step of (3-1) concentrating the lactic acid bacteria-treated milk fluid or concentrating and drying the lactic acid bacteria-treated milk fluid.

3. The method according to claim 1, further comprising the step of (3-2) drying the lactic acid bacteria-treated milk fluid.

4. The method according to claim 1, wherein the milk fluid contains whey protein as the milk-derived protein but does not contain casein.

5. The method according to claim 1, wherein
the milk fluid contains casein, or casein and whey protein, as the milk-derived protein,
the step (2) includes maintaining the milk fluid containing the lactic acid bacteria until achieving a pH within a range of 6.0 to 6.5 to obtain a lactic acid bacteria-treated milk fluid with a pH within the range.

6. The method according to claim 4, wherein the high-protein dairy material is at least one member selected from the group consisting of whey protein concentrate (WPC) and whey protein isolate (WPI).

7. The method according to claim 5, wherein the high-protein dairy material is at least one member selected from the group consisting of milk protein concentrate (MPC), milk protein isolate (MPI), and micellar casein concentrate (MCC).

8. A lactic acid bacteria-treated high-protein dairy material, which is in a liquid form, comprising a milk-derived protein in an amount of 50 parts by mass or more per 100 parts by mass of a total solids content,
the lactic acid bacteria-treated high-protein dairy material comprising at least dead lactic acid bacteria cells, diacetyl, and 3-hydroxy-2-butanone,
the lactic acid bacteria-treated high-protein dairy material having a pH within a range of 5.2 to 6.5.

9. The lactic acid bacteria-treated high-protein dairy material according to claim 8, wherein the lactic acid bacteria-treated high-protein dairy material contains whey protein as the milk-derived protein but does not contain casein.

10. The lactic acid bacteria-treated high-protein dairy material according to claim 8, wherein
the lactic acid bacteria-treated high-protein dairy material contains casein, or casein and whey protein, as the milk-derived protein, and
the lactic acid bacteria-treated high-protein dairy material has a pH within a range of 6.0 to 6.5.

11. A semi-solid or solid lactic acid bacteria-treated high-protein dairy material obtained by concentrating and/or drying the lactic acid bacteria-treated high-protein dairy material in a liquid form of claim 8.

12. A method for producing a food or drink product, comprising the step of adding the high-protein dairy material obtained according to the method of claim 1 to a food or drink product.

13. A food or drink product comprising the lactic acid bacteria-treated high-protein dairy material of claim 8.

14. A method for improving flavor of a high-protein dairy material, comprising the steps of
(1) preparing a milk fluid from a dairy material, the milk fluid having a total solids content of 5 to 15 mass % and containing a milk-derived protein in an amount of 50 parts by mass or more per 100 parts by mass of the total solids content, and
(2) adding lactic acid bacteria to the milk fluid and maintaining the milk fluid containing the lactic acid bacteria until achieving a pH within a range of 5.2 to 6.5 to obtain a lactic acid bacteria-treated milk fluid with a pH within the range.
